(19) United States
(12) Patent Application Publication
(10) Pub. No.: US 2006/0294223 A1
(43) Pub. Date: Dec. 28, 2006

(54) Pre-fetching and DNS resolution of hyperlinked content

(75) Inventors: Dane A. Glasgow, Los Gatos, CA (US); Jay C. Jacobs, Danville, CA (US); Neel I. Murarka, Cupertino, CA (US); Nicholas A. Whyte, Mercer Island, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/165,513

(22) Filed: Jun. 24, 2005

(51) Int. Cl. G06F 15/173

(52) U.S. Cl. 709/224

(57) ABSTRACT

A web accelerator reduces web latency experienced when retrieving and displaying content. The web accelerator includes an interceptor component, a resolver component, a predictor component and a tracer component. The interceptor component captures web requests. The web requests are tracked by the tracer component, which logs the web requests to generate a statistical model that reflects web browsing activity. The predictor component utilizes the statistical model to predict subsequent web requests, and the resolver component resolves hostnames specified in the subsequent web requests and pre-loads content specified in the subsequent web requests when there is a strong likelihood that a user is interested in the content specified in the subsequent web requests.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Currently, pre-fetching tools reduce latency by pre-fetching all objects contained in a Hypertext Markup Language (HTML) file. Upon receiving a request for a webpage, the objects, which include image data, are pre-fetched.

For instance, when a client computer generates a Hypertext Transport Protocol (HTTP) request for a webpage located at a server computer, the HTTP request is communicated to the server computer. The server computer responds to the HTTP request by sending the HTML file associated with the HTTP request to the client computer. If the server computer is executing a pre-fetching tool, the pre-fetching tool processes the HTML file and pushes all objects contained in the HTML file to the client computer. The client computer receives the HTML file and the pushed objects, which may be of no interest to the client computer when the client computer has chosen to request a different HTML file.

Current pre-fetching tools pre-fetch all objects included in a webpage without regard to whether a user is interested in all objects contained within the web page. Accordingly, a need arises to efficiently pre-fetch objects that match the user's interest.

### SUMMARY

A web accelerator reduces web latency by implementing pre-loading heuristics that predict user behavior and pre-load web content. The web accelerator preemptively opens connections to locations storing the web content and pre-loads the web content based on past user behavior. The speculative nature of the web accelerator reduces web latency when a user generates a request specifying the pre-loaded content.

The web accelerator may include an interceptor component, predictor components and a resolver component. The interceptor component intercepts web requests generated by the user. The predictor components utilize the web requests to predict future requests. The resolver component preemptively sets up connections to locations specified in the future requests and pre-loads the web content stored at the locations specified in the future requests. Accordingly, the web accelerator reduces the web latency experienced by the user when a subsequent request generated by the user matches the future request predicted by the predictor components.

This Summary is provided to introduce a selection of concepts in a simplified form that are further described below in the Detailed Description. This Summary is not intended to identify key features or essential features of the claimed subject matter, nor is it intended tot be used as an aid in determining the scope of the claimed subject matter. Additional advantages and novel features will be set forth in the description which follows and in part may become apparent to those skilled in the art upon examination of the following.

### BRIEF DESCRIPTION OF THE DRAWINGS

FIG. 1 illustrates a network diagram of a computing environment adapted to implement embodiments of the present invention;

FIG. 2 illustrates a component diagram of a web accelerator utilized by embodiments of the present invention;

FIG. 3 illustrates a result page responding to a query generated by a client computer;

FIG. 4 illustrates a flow diagram implementing a web acceleration method utilized by embodiments of the present invention;

FIG. 5 illustrates a message diagram of communications messages conducted between a client computer and a sever computer when implementing the web acceleration method utilized by embodiments of the present invention;

FIG. 6 illustrates communication messages generated by a client computer, a proxy device and a server computer in a network environment utilizing the web accelerator; and

FIG. 7 illustrates a flow diagram implementing a pre-load method utilized by embodiments of the present invention.

### DETAILED DESCRIPTION

Embodiments of the present invention provide a web accelerator to reduce web latency experienced at a client computer. The web accelerator pre-loads web content based on past browsing activities, bandwidth availability or current requests generated by the client computer. So, the web accelerator may pre-load web content that matches a user's interest. Moreover, embodiments of the present invention provide a method to maintain a database log when responding to and receiving requests from the web accelerator. The integrity of the database log is maintained by assuring the database log contains information on actual requests generated by the client computer in response to user requests and not speculative requests generated by the web accelerator. Accordingly, embodiments of the present invention provide a web accelerator that maintains the integrity of the database log.

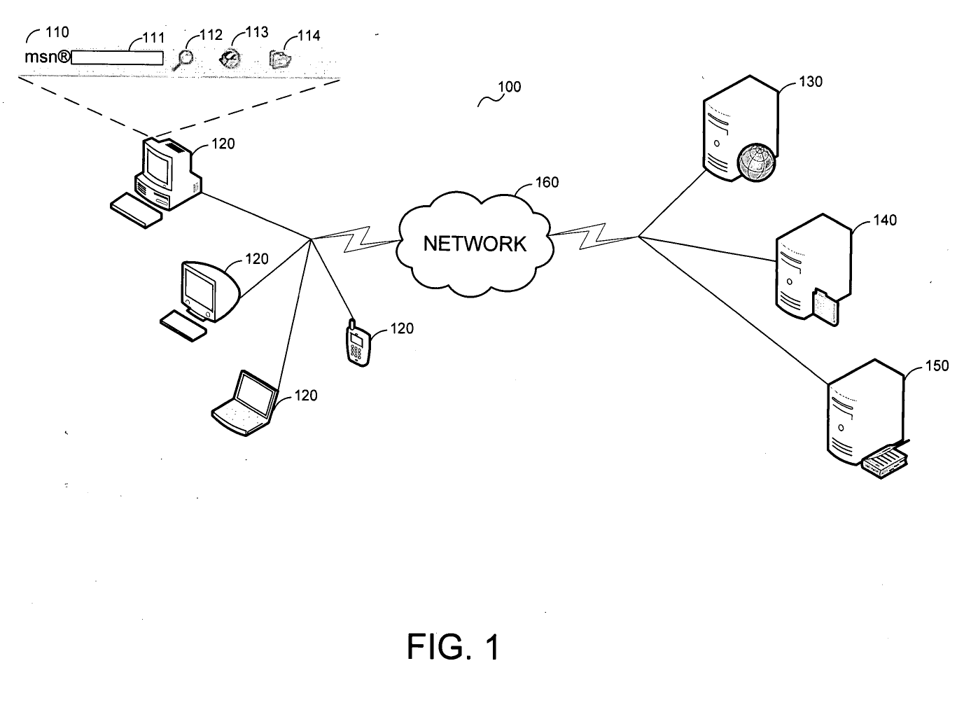

FIG. 1 illustrates a network diagram of a computing environment 100 adapted to implement embodiments of the present invention.

The computing environment 100 is not intended to suggest any limitation as to scope or functionality. Embodiments of the present invention are operable with numerous other special purpose computing environments or configurations. With reference to FIG. 1, the computing environment 100 includes client computers 120, server computers 130-150 and a communication network 160.

The client and server computers 120-150 each have a processing unit, coupled to a variety of input devices and computer-readable media via a communication bus. The computer-readable media may include computer storage and communication media that are removable or non-removable and volatile or non-volatile. By way of example, and not limitation, computer storage media includes electronic storage devices, optical storages devices, magnetic storage devices, or any medium used to store information that can be accessed by client computers 120, and communication media may include wired and wireless media. The input devices may include, mice, keyboards, joysticks, controllers, microphones or any suitable device for providing a user input to the client computers 120.

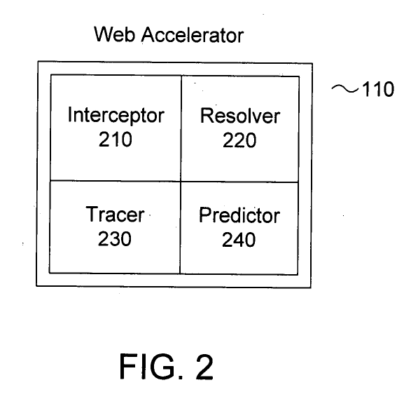

The client computers 120 may store application programs that provide computer-readable instructions and data structures to implement heuristics of the application programs. In an embodiment of the present invention, the client computers 120 store web browser programs and instructions that implement a web accelerator 110. The web accelerator 110 may be a toolbar that is part of an application program, such as, for example, a web browser program stored on the client computer 120 or the web accelerator 110 may be a toolbar associated with an underlying operating system, such as, for example, WINDOWS®. The toolbar includes a search field 111 to receive search requests from a user, a search button 112 to initiate the search request on a computer, e.g., search engine 140, a history button 113 to retrieve a search history associated with the user, and a folder button 114 to display locations, links or content cached on the client computer 120. The web accelerator 110 is described in more detail below with reference to FIG. 2. In an alternate embodiment of the present invention, the web accelerator 110 is a program that executes in a background state.

The client computers 120 communicate with server computers 130-150 over the communication network 160. The communication network 160 may be a local area network, a wide area network, or the Internet. The server computers 130-150 may include a web server 130, a search engine 140, and a directory server 150. The search engine 140 receives search requests generated by the user and generates a result set, which may include uniform resource locations (URLs) of servers across the globe, such as, for example, web server 130. The directory server 150 translates hostnames of the client or server computers 120-150 to internet protocol (IP) addresses to enable message communication between the client and server computers 120-150. In an alternate embodiment of the present invention, services provided by the server computers 130-150 may be implemented on a single server computer. The network configuration illustrated in FIG. 1 is exemplary and other configurations are within the scope of the present invention.

FIG. 2 illustrates a component diagram of the web accelerator 110 utilized by embodiments of the present invention.

The web accelerator 110 may include an interceptor component 210, a resolver component 220, a tracer component 230, and a predictor component 240. The interceptor component 210 may intercept responses sent to the client computer 120 and requests, which may be HTTP requests, generated at the client computer 120. The interceptor component 210 listens for the requests generated by an application program stored on the client computer 120, such as, for example, the web browser program. The interceptor component 210 forwards the requests or responses to the resolver component 220, tracer component 230 or predictor component 240 for further processing.

The predictor component 240 predicts subsequent requests that the client computer 120 may generate based on responses and previous requests received from the interceptor component 210, current bandwidth utilization, and the request generated by the web browser program. The responses may include web content and hint information, such as, for example, server-side access histories. The predictor component 240 parses the responses to determine the user's interests and predicts the subsequent requests utilizing the user's interests. Also, the predictor component 240 checks the current bandwidth utilization to determine whether the subsequent requests should be sent to a server, such as, for example, web sever 130 or search engine 140. When the bandwidth utilization is below a specified threshold, the subsequent requests are sent to the server. In an embodiment of the present invention, the predictor component may include components executing on different servers or clients.

The resolver component 220 resolves hostnames included in the subsequent requests generated by the predictor component 240. The resolver component 220 performs a Domain Name System (DNS) lookup to translate hostnames to IP addresses. The resolver component 220 may communicate with a name server, such as, for example, the directory server 150, to translate the hostnames included in the subsequent requests. The resolver component 220 may speculatively open connections to the IP addresses translated from the hostnames.

The tracer component 230 tracks the requests intercepted by the interceptor component 210 to generate a statistical model that represents relationships between requests generated during a typical user browsing session. For instance, the statistical model may illustrate a user's request for msn.com is typically followed with a request for a news link in eighty percent of the browsing sessions associated with the user. The statistical model may be utilized to rank the subsequent requests generated by the predictor component 240. Accordingly, when the bandwidth utilization is below the specified threshold, the subsequent request having the highest rank is pre-loaded. In an alternate embodiment of the present invention, a rank threshold is specified, and the subsequent requests above the specified rank threshold are pre-loaded.

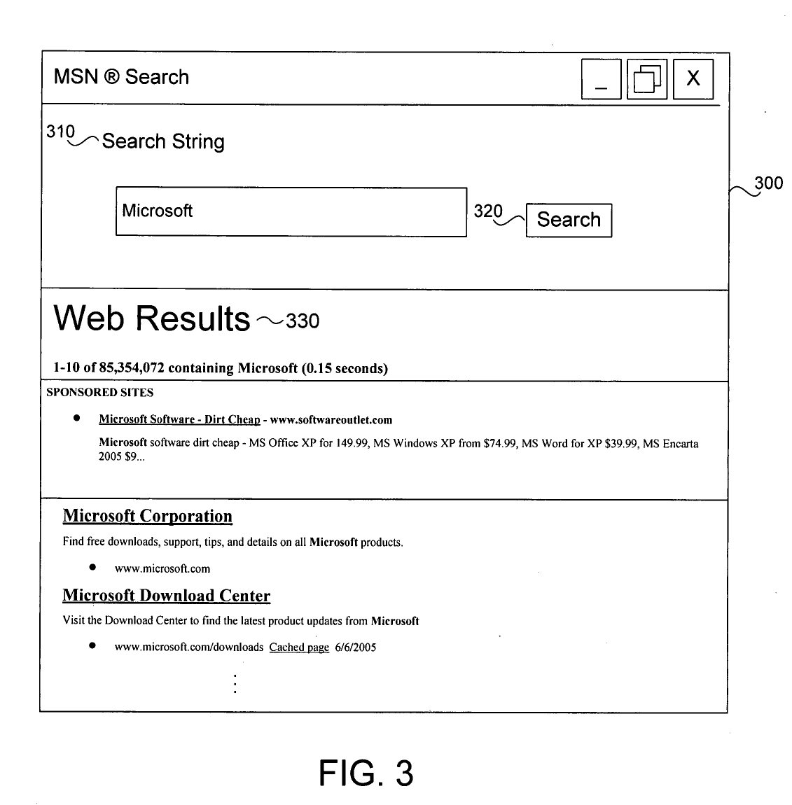

FIG. 3 illustrates a result page 300 generated by the client computer 120 when responding to a query. The result page 300 may be created at a server computer, such as for example, the search engine 140. The result page 300 includes a search string field 310, a search button 320 and a results listing 330. The search string field 310 allows a user to enter a search string. The search button 320 initiates a search by sending the search string to the search engine 140, when the user depresses the search button 320. The search engine 140 generates the results listing 330, which is a collection of URLs and sends the results listing 330 to the client computer 120. The search engine 140 may include hint information, a hidden data structure, with the results listing 330. The hint information may include statistical information, click through rates, ranking information, click tracking information, byte information and redirect information. The statistical information may define a click probability for each URL. The click through rate represents a percentage of users that clicked on a URL included in the results listing 330, when the search string specified by the user was entered by other users. The byte information is associated with each URL and provides the number of bytes that would be transmitted when a user requests the URL. The click tracking information provides a view of requests made by users requesting a URL. The ranking information provides a rank assigned to each URL based on search engine metrics, such as, for example, search string frequency. The redirect information provides the URL of the search engine 140 and a destination server, such as, for example, web server 130, hosting the web content. The redirect information allows the search engine 140 to accurately log click requests generated at the client computer 120. Additionally, in an embodiment of the present invention, the redirect information may specify a URL unrelated to the current search string or results listing 330. Here, the redirect information may be direct URLs to third party servers or redirect URLs to servers absent from the result listing 330 having further redirect URLs. Accordingly, the hint information is processed by the web accelerator 110 to accelerate URL redirects by determining which URLs should be pre-loaded.

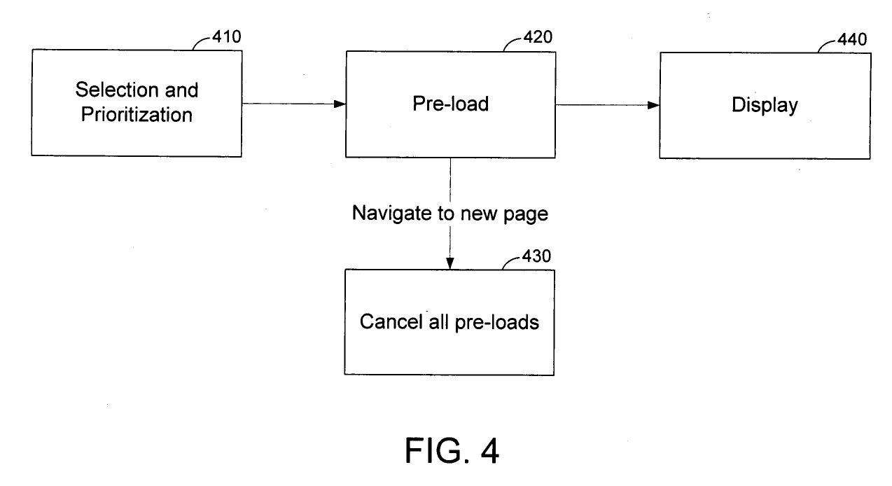

FIG. 4 illustrates a flow diagram implementing a web acceleration method utilized by embodiments of the present invention. The web acceleration method includes selection and prioritization of URLs, in operation 410, pre-loading the selected URLs, in operation 420, and displaying the pre-loaded content associated with the URLs when a user clicks on the URLs, in operation 440. Furthermore, when the client computer's 120 inquiry changes, the pre-loads are cancelled to avoid wasteful use of computing resources, in operation 430.

The web accelerator 110 enhances a user's overall browsing experience by judiciously selecting and prioritizing URLs, in operation 410. The web accelerator 110 may use several server or client based metrics to prioritize the URLs. The server-based metrics may be included in the hidden data structure provided by the response to the client computer's inquiry.

The metrics may include a server-based aggregate of user click through rates defining the behavior of previous users. The click through rates may be a statistical measurement of a collection of previous users' immediate response to a URL. For instance, when a user generates a search for “Microsoft,” the search engine will return a set of URLs related to “Microsoft” in the response. The search engine may include information that informs the web accelerator that ninety percent of the users that search for “Microsoft” click on a windows URL. The web accelerator 110 utilizes the click through rate information for each URL in the response and may decide to select the windows URL as a priority URL when pre-loading content because of the large click through rate associated with the windows URL.

Another metric that the web accelerator 110 may utilize when prioritizing the URLs may be popularity of the URLs, which is the total number of other URLs that link to a current URL. The popularity metric allows the web accelerator to measure the current URL's overall visibility and is a server-based measurement included in the response, which prioritizes each URL associated with the client request. Accordingly, the web accelerator 110 may utilize the popularity metric to give the most popular URLs a higher priority when determining which content to pre-load.

Another server-based metric utilized by the web accelerator 110 may be a typical time on page, which is an average time spent on each URL by a collection of users. The time metric may measure the importance of the page or may indicate the page's utility. Thus, if each user that clicks on the URL spends a large amount of time on the page associated with the URL, and the amount of time is greater than a specified threshold, such as, for example, five seconds, the page is given a high priority. Accordingly, the web accelerator 110 utilizes the time metric when pre-loading content to decide which URLs should be given priority.

The client metrics may include previous browsing activity, which may include the access history of the user. The previous browsing activity may include previously visited URLs that are not cached to aid the web accelerator 110 when detecting user patterns. For instance, the user access history may illustrate that previous searches conducted by the user for “Microsoft,” were accompanied a click on a security URL. The web accelerator may utilize the previous browsing activities to prioritize the security URL and preload the content associated with the security URL. In an embodiment of the present invention, the client browsing activity is monitored and stored in an encrypted format on the client computer 120 to ensure privacy of the client browsing activity.

Another client metric may include actual time on page, which is determined from client based monitoring of time spent on URLs during previous browsing activities. Similar to the server time metric, the client time metric enables the web accelerator 110 to determine the importance of the URLs. However, the client time metric is tuned to the idiosyncrasies of a current user and may be a better metric, if available, to measure importance of the URLs.

The sever and client based metrics defined above may be combined in any reasonable manner, when determining which URLs to pre-load. Also, the web accelerator 110 may prioritize URLs according to client or server based rules on how to pre-load web content from specified URLs, or content meta tags, specified by an author or publisher of the content, which instruct the web accelerator 110 how to prioritize URLs associated with the content.

After the URLs are prioritized and selected, the web accelerator 110 pre-loads the selected URLs, in operation 420. Pre-loading the selected URLs include translating the selected URLs to IP addresses and speculatively opening connections to the IP address. Furthermore, pre-loading may utilize a local cache of the web browser to store web content associated with the selected URLs. In an alternate embodiment of the present invention, pre-loading is initiated based on bandwidth utilization at the client. Accordingly, a bandwidth threshold may control how many URLs are pre-loaded. When the client or server bandwidth utilization is below the specified bandwidth threshold, the web accelerator pre-loads the URLs, which synchronously downloads the content associated with the URLs to the local cache based on the priorities assigned to the URLs.

When a user attempts to navigate to a new page, the web accelerator 110 cancels all pre-loads associated with a previous request, in operation 430. In an embodiment of the present invention, canceling the pre-loads includes closing connections to IP addresses that were speculatively opened based on the previous request and stopping the retrieval of web content associated with the previous request.

When the user attempts to display the web content associated with user requests, the web accelerator 110 processes the user requests and sends the web content to an application program, such as, for example, the web browser or display device, in operation 440. The web browser may utilize various display implementations. Here, the user requests may be intercepted at an application layer or network layer. The web accelerator 110 may create multiple instances of the web browser to process the responses to the user requests. Alternatively, the web browser may utilize multiple frames to load the URLs in a single instance of the web browser. Moreover, tabs may be utilized by the web browser to provide a single window interface with layered web browser windows to display the URLs. In an alternate embodiment of the present invention, the web browser may utilize iframes to open multiple pages that are hidden until the user clicks on the URLs.

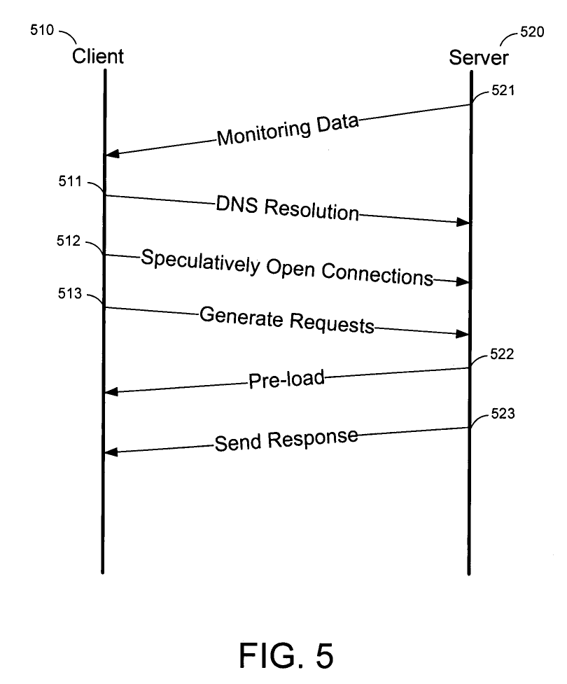

FIG. 5 illustrates a message diagram of communication messages conducted between a client computer 510 and a sever computer 520 when implementing the web acceleration method utilized by embodiments of the present invention.

The server computer 520 sends a monitoring data message 521 to the client computer 520, after receiving a request generated at the client computer 520. In response, the client computer 510 generates a DNS resolution message 511. After receiving a DNS response, the client computer 510 generates messages to speculatively open connections 512 based on the heuristics performed by the web accelerator 110. The client computer 510 generates a request message for content stored on the server computer 520. The server computer 520 responds by generating a pre-load message 522 and a response message to the client computer 510. The pre-load and response messages 522-523 may be piggybacked together when transmitting to the client computer 510.

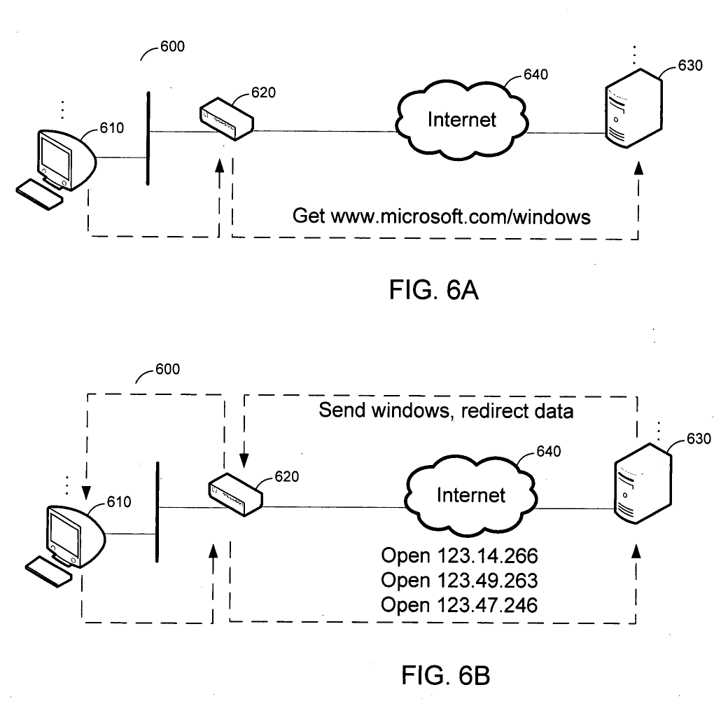

FIG. 6 illustrates communication messages generated by a client computer 610, a proxy device 620 and a server computer 630 in a network environment 600 utilizing the web accelerator 110. The network environment 600 includes the client computer 610, the proxy device 620, a communication network 640, such as the Internet, and the server computer 630. In an alternate embodiment of the present invention, the proxy device 620 is part of the client computer 610.

With reference to FIG. 6A, when the client computer 610 generates a Hypertext Transport Protocol (HTTP) request for a webpage located at microsoft.com, the HTTP request is communicated to the proxy device 620. The proxy device 620 checks a cache on the proxy device 620 to determine whether the webpage is stored in the cache. When the webpage is stored in the cache of the proxy device 620, the proxy device 620 responds to the HTTP request and sends the webpage to the client computer 610.

On the other hand, when the cache of the proxy device 620 does not store the webpage, the request is transmitted across the communication network 640 to the server computer 630. With reference to FIG. 6B, the server computer 630 responds to the HTTP request by transmitting hint information that includes redirect data and the webpage specified in the HTTP request to the proxy device 620. The proxy device 620 receives the hint information and webpage, stores the webpage in the cache of the proxy device 620, and transmits the webpage and the hint information to the client computer 610. The client computer 610 executes the web accelerator 110, which processes the hint information and speculatively generates requests to open connections for objects included in the webpage, such as, URLs to other server computers. The open connection requests are generated by the web accelerator 110 based on client profile information stored on the client computer 110 and hint information received from the server computer 630, which indicates the objects that the user cares about.

When displaying the webpage, the client computer 610 generates HTTP requests for objects included in the webpage. The proxy device 620 receives the HTTP requests for the objects and checks the cache of the proxy device 620 to determine whether the objects specified in the HTTP requests are stored in the cache of the proxy device 620. When the objects specified in the HTTP requests are stored in the cache of the proxy device 620, the proxy device 620 retrieves the objects specified in the HTTP requests from the cache of the proxy device 620 and sends the objects to the client computer 610. In an alternate embodiment of the present invention, the cache is a browser cache stored on the client computer 610.

The redirect data included in the hint information received from the server computer 630 allows the client computer 610 to locate the original publisher of the webpage and enables the server computer 630 to efficiently track the requests initiated by the client computer 610 in a log database that stores client-based requests that reflect actual client click requests and not pre-load activity generated by the web accelerator 110. In an embodiment of the present invention, the redirect data allows the log database to provide click traffic integrity while reducing the latency experienced at the client computer 610. The redirect data includes an original URL modified, by the server computer 630, to point to the server computer 630 and the original URL, which points to web content stored on another server computer. Thus, when the client computer 610 clicks on a URL associated with the web content, the server computer 630 is informed that the client computer 610 generated a click request, and the server computer 630 updates the log database with the click request information while the request is processed concurrently at the other server computer. Accordingly, the log database provides a honest perception of user behavior and does not include information associated with pre-loading activities initiated by the web accelerator 110.

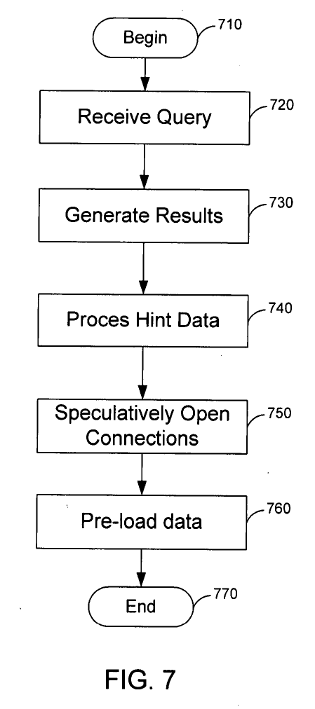

FIG. 7 illustrates a flow diagram implementing a pre-load method utilized by embodiments of the present invention.

With reference to FIGS. 1 and 7, the server computer 140 receives search requests from client computer 120, in operation 720. The server computer 140 generates a result set based on the search requests received from the client computer 120, in operation 730. The server computer 140 generates hint data, which includes statistical information on past browsing behavior and redirect information. The result set and hint data are coupled in a data structure and transmitted to the client computer 120. The client computer 120 receives the data structure and the web accelerator 110 processes the data structure, in operation 740. The web accelerator 110 stored on client computer 120 generates requests to speculatively open connections on server computers, such as, for example, web server computer 130, in operation 750. Furthermore, the web accelerator 110 pre-loads content on the client computer 120 that will likely match a user's interest based on the statistical information contained in the hint data and past browsing activities specific to the user, in operation 760. The pre-loaded content is displayed to the user when a subsequent request for content includes a request for the pre-loaded content. The method ends in operation 770.

In sum, a web accelerator provides predictive pre-loading of information and breaks sequential browsing behavior based on client or server access histories that relate to a current URL specified by the client. The web accelerator ensures the privacy of the browsing behavior of the client when performing acceleration heuristics. Moreover, the web accelerator processes a hint data structure to determine which URLs should be pre-loaded, the hint data structure allows a server computer to accurately perceive client click activities for storage in a log database. Additionally, an application, such as, for example, a word processor or electronic mail program, may be integrated with the web accelerator, and the web accelerator may pre-load URLs based on an analysis of a user's behavior in response to the user's click activity. The foregoing descriptions of the invention are illustrative, and modifications in configuration and implementation will occur to persons skilled in the art. For instance, while the present invention has generally been described with relation to FIGS. 1-7, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A computer-implemented method to reduce web latency, the computer-implemented method comprising:
generating profile information that models web browsing behavior;
receiving webpage data, the webpage data includes pre-load information; and
utilizing the pre-load information and profile information to pre-load less than all of the webpage data.

2. The computer-implemented method according to claim 1, wherein the webpage data includes search results.

3. The computer-implemented method according to claim 1, wherein the pre-load information is hidden in the webpage data.

4. The computer-implemented method according to claim 1, further comprising:
pre-loading a subset of data included in the webpage data.

5. The computer-implemented method according to claim 4, wherein pre-loading the subset of data included in the webpage data further comprises:
speculatively resolving hostnames and speculatively opening connections based on the profile information or the pre-load information.

6. The computer-implemented method according to claim 5, wherein pre-loading the subset of data included in the webpage data further comprises:
loading a cache with the subset of data.

7. A web accelerator executing computer-readable components, the web accelerator comprising:
an interceptor component to intercept requests;
a predictor component to predict subsequent requests utilizing hint information received in response to the requests; and
a resolver component to resolve host names included in the subsequent requests received from the predictor component.

8. The web accelerator according to claim 7, wherein the predictor component predicts the subsequent requests based on bandwidth availability and the hint information.

9. The web accelerator according to claim 7, wherein the subsequent requests include requests for uniform resource locations.

10. The web accelerator according to claim 7, further comprising a tracer component to track requests intercepted by the interceptor.

11. The web accelerator according to claim 10, wherein the tracer component creates a statistical model based on requests intercepted by the interceptor.

12. The web accelerator according to claim 7, wherein the subsequent requests are assigned a rank according to a likelihood that a client is interested in information specified in the subsequent requests.

13. The web accelerator according to claim 12, wherein the predictor component, determines whether the rank of the subsequent requests are above a specified threshold, to pre-load the subsequent requests having the rank above the specified threshold.

14. A computer-implemented method to maintain the integrity of a log database having click traffic data, the computer-implemented method comprising:
receiving user click requests;
logging the user click requests in the log database;
generating a result set and redirect data based on the user click requests; and
transmitting the result set and redirect data to a user.

15. The computer-implemented method according to claim 14, wherein the log database does not include speculative requests.

16. The computer-implemented method according to claim 14, wherein the log database is utilized to generate hint information.

17. The computer-implemented method according to claim 14, wherein the redirect data is not related to the result set.

18. The computer-implemented method according to claim 14, further comprising:
pre-loading web content based on the redirect data.

19. The computer-implemented method according to claim 18, wherein the redirect data includes location information.

20. The computer-implemented method according to claim 19, wherein pre-loading web content based on the redirect data further comprises:
ranking the location information according to the user click requests in the log database; and
speculatively opening connections to sites specified in the location information, when the rank of the location information is above a specified threshold.
